(19) United States
(12) Patent Application Publication
(10) Pub. No.: US 2022/0274308 A1
(43) Pub. Date: Sep. 1, 2022

(54) Biodegradable Products and Methods of Production

(71) Applicants: RJSalter, LLC, Corvallis, OR (US); Eastman Chemical Company, Kingsport, TN (US)

(72) Inventors: Robert SALTER, Portland, OR (US); Jos Simon DE WIT, Kingsport, TN (US); Andrew Ervin MCLEOD, Jonesborough, TN (US)

(73) Assignees: RJSalter, LLC, Corvallis, OR (US); Eastman Chemical Company, Kingsport, TN (US)

(21) Appl. No.: 17/638,043

(22) PCT Filed: Sep. 1, 2020
(86) PCT No.: PCT/US2020/048916

§ 371 Date: Feb. 24, 2022

Related U.S. Application Data
(60) Provisional application No. 62/895,315, filed on Sep. 3, 2019.

(51) Int. Cl. B29C 48/09; C08L 1/14; B29C 48/00; A47G 21/18

(52) U.S. Cl. CPC B29C 48/09; C08L 1/14; B29C 48/022; B29C 48/0018; A47G 21/18; C08L 2201/06; B29K 2001/12

(57) ABSTRACT

Example biodegradable tubular members and methods of producing biodegradable tubular members are described. A biodegradable product includes an elongated tubular member. The elongated tubular member includes one or more cellulose esters and a plurality of pores in the tubular member. The plurality of pores are sized and structured in the elongated tubular member to allow permeation or infiltration of at least one of water or bacteria into at least a portion of the plurality of pores and promote biodegradability of the elongated tubular member.

### CROSS-REFERENCE TO RELATED APPLICATIONS

This application claims priority to U.S. Provisional Application No. 62/895,315 filed on Sep. 3, 2019 the disclosure of which is incorporated herein, in its entirety, by this reference.

### BACKGROUND

There is a well-known global issue with waste disposal, particularly of large volume consumer products such as plastics or polymers that are not considered biodegradable within acceptable temporal limits. There is a public desire to incorporate these types of wastes into renewed products through recycling, reuse, or otherwise reducing the amount of waste in circulation or in landfills. This is especially true for single-use plastic articles/materials.

As consumer sentiment regarding the environmental fate of single-use plastics, such as straws, to-go cups, and plastic bags, are becoming a global trend, plastics bans are being considered/enacted around the world in both developed and developing nations. Bans have extended from plastic shopping bags into straws, cutlery, and clamshell packaging, for example, in the United States alone. Other countries have taken even more extreme steps, such as the list of ten single-use articles slated to be banned, restricted in use, or mandated to have extended producer responsibilities throughout the European Union. As a result, industry leaders, brand owners, and retailers have made ambitious commitments to implement recyclable, reusable or compostable packaging in the coming years. While recyclable materials are desirable in some applications, other applications lend themselves better to materials that are compostable and/or biodegradable, such as when the article is contaminated with food or when there are high levels of leakage into the environment due to inadequate waste management systems.

There is a market need for single-use consumer products that have adequate performance properties for their intended use and that are compostable and/or biodegradable. It would be beneficial to provide products having such properties and that also have significant content of renewable, recycled, and/or re-used material.

### SUMMARY

Cellulose acetate is a renewable material in that the backbone of the molecule is cellulose. The acetyl groups attached to the cellulose backbone that make cellulose acetate an ester affect the properties of the polymeric material and can make cellulose acetate more useful for solvent cast or solvent extruded articles e.g., single-use products such as straws, cutlery, cups and plates, and for providing better end use properties.

While there are a variety of compostable and biodegradable materials, each of them has shortcomings in either cost, processing, or performance. Some compostable alternatives to cellulose acetate are polylactic acid (PLA) and uncoated paper. While uncoated paper composts relatively quickly, the consumer experience is often rather poor, as articles such as straws become soggy and lack the stiffness required during use.

In embodiments, a biodegradable product includes an elongated tubular member including one or more cellulose esters and a plurality of pores in the elongated tubular member. The plurality of pores are sized and structured in the elongated tubular member to allow permeation or infiltration of at least one of water or bacteria into at least a portion of the plurality of pores and promote biodegradability of the elongated tubular member. In embodiments, the elongated tubular member is biodegradable (under industrially composting conditions described in ASTM D5338) or is industrially compostable (as described in ASTM D6400, EN 13432 or ISO 17088). In embodiments, the elongated tubular member is biodegradable (under industrially composting conditions described in ASTM D5338) and is industrially compostable (as described in ASTM D6400, EN 13432 or ISO 17088).

In embodiments, the elongated tubular member is home compostable. In embodiments, the elongated tubular member is biodegradable under EN 13432 biodegradation tests conducted at ambient temperature. In an embodiment, the elongated tubular member biodegrades within 24 weeks in an industrial composting environment (under conditions described in ASTM 6200). In an embodiment, the elongated tubular member biodegrades within 26 weeks in a home composting environment. In an embodiment, the elongated tubular member biodegrades within 50 weeks in fresh surface water.

In embodiments, a biodegradable elongated tubular member (e.g., tube) is provided that is made from biodegradable cellulose diacetate (BCA). In an embodiment, the cellulose acetate has an acetyl degree of substitution (DS Ac) from about 0.05 to about 2.95 and the tubular member comprises a wall having a porosity of at least about 10%. In embodiments, the elongated tubular member comprises a wall having an average porosity from about 20% to about 70%, or from about 40% to about 60%.

In embodiments, the elongated tubular member comprises a wall having a cross section with an inner portion or surface facing radially inward to the inside of tubular member and an outer portion or surface facing radially outward from the tubular member, wherein the outer portion or surface includes a skin layer having a density higher (or lower porosity) than the remainder of the wall cross section.

In embodiments, the elongated tubular member comprises a total of 0% to about 2 wt % of plasticizers or other processing-aid additives. In an embodiment, the elongated tubular member is free of plasticizers or other processing-aid additives. In embodiments, the elongated tubular member comprises a total of 0 wt % to about 2 wt % of any additives. In an embodiment, the elongated tubular member is free of any additives. In embodiments, the elongated tubular member has a total extractables amount of about 10 mg/dm² or less.

In embodiments, the elongated tubular member is configured to be useful as a drinking straw. In an embodiment, the elongated tubular member comprises a wall thickness in the range from 3 mils to about 20 mils (about 76 nm to about 508 nm), or from about 4 mils to about 15 mils (about 102 nm to about 381 nm). In an embodiment, the elongated tubular member has an outer diameter in the range from about 1 mm to about 20 mm and a length from about 50 mm to about 500 mm.

In another aspect, a process for producing a biodegradable elongated tubular member is provided that comprises providing a cellulosic dope composition comprising a biodegradable cellulosic component dissolved in one or more solvents, said biodegradable cellulosic component comprising one or more cellulose esters. The process also includes processing the cellulosic dope composition to form a tubular shape. The process also includes transferring the one or more solvent(s) from the tubular shaped cellulosic dope composition by mass transfer into a solvent capturing medium that comprises one or more non-solvents that removes the one or more solvents from the cellulosic dope composition to form a substantially solid tube having a plurality of pores. In embodiments, the process also includes processing the substantially solid tube to provide the biodegradable elongated tubular member.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE FIGURES

FIG. 1A is a side view of a biodegradable product, according to an embodiment.

FIG. 1B is a cross-sectional view of the biodegradable product of FIG. 1A taken along line 1-1, according to an embodiment.

FIG. 1C is a cross-sectional view of the biodegradable product of FIG. 1A taken along line 1-1, according to an embodiment.

FIG. 1D is a cross-sectional view of the biodegradable product of FIG. 1A taken along line 1-1, according to an embodiment.

FIG. 1E is a cross-sectional view of the biodegradable product of FIG. 1A taken along line 1-1, according to an embodiment.

FIG. 2 is diagram of a spinning process, according to an embodiment.

FIG. 3 is an enlarged cross-sectional view of area A of FIG. 2, according to an embodiment.

FIGS. 4A and 4B are scanning electron microscope (SEM) images of a cross-section of a straw wall.

FIG. 5 is a side view of a home composition bin, according to an embodiment.

FIG. 6 is a flow diagram of a method of producing a biodegradable product, according to an embodiment.

### DETAILED DESCRIPTION OF THE VARIOUS EMBODIMENTS

Embodiments disclosed herein relate to biodegradable drinking straws and other products that may be produced through a controlled phase inversion, as well as methods and processes for producing such biodegradable drinking straws and other products. It is desirable to product drinking straws and other products that are biodegradable and also include organoleptic properties similar to that of conventional plastic counterparts. As described in greater detail herein, products such as drinking straws, stirring sticks, or other elongated tubular or capsule members that are manufactured from one or more cellulose esters can be configured to provide a biodegradable replacement to plastic products. Using cellulose in biodegradable products also is advantageous because cellulose is non-toxic as the product biodegrades.

In one aspect, biodegradable elongated tubular articles are provided that comprise one or more cellulose esters. In embodiments, an elongated tubular member comprising of one or more cellulose esters and a plurality of pores is provided, where the elongated tubular member is biodegradable under the industrially composting conditions described in ASTM D5338 or is industrially compostable as described in at least one of ASTM D6400, EN 13432 or ISO 17088. In one embodiment, the elongated tubular member is biodegradable under the industrially composting conditions described in ASTM D5338 and is industrially compostable as described in at least one of ASTM D6400, EN 13432 or ISO 17088.

In embodiments, the elongated tubular member is biodegradable under EN 13432 biodegradation tests conducted at ambient temperature. In embodiments, the elongated tubular member is home compostable as described in NF T T51-800 Plastic-specifications suitable for home composting.

In embodiments, the elongated tubular member biodegrades within 24 weeks in an industrial composting environment under conditions described in ASTM 6200. In embodiments, the elongated tubular member biodegrades within 26 weeks in a home composting environment under conditions described herein for home composting. In embodiments, the elongated tubular member biodegrades within 50 weeks in fresh surface water under conditions described herein for freshwater biodegradation.

In embodiments, the articles described herein utilize biodegradable cellulose diacetate (BCA). It is noted that the level of substitution of hydroxyl groups by acetyl groups can theoretically vary from zero for neat cellulose to three, which is cellulose triacetate. The ability to process such polymers varies with the acetyl level. In an embodiment, cellulose diacetate with an average of about 2.5 out of the 3 hydroxyl groups replaced with acetyl groups, has desirable processability. In addition, biodegradability generally improves with decreasing acetyl levels, where useful biodegradation has been found with a level of about 2.5.

Although embodiments are provided utilizing BCA, it is noted that in certain embodiments cellulose esters can also include mixed cellulose esters with any combination of acetyl, propionyl, butyryl, or other aliphatic or aromatic acyl groups. The ability to process these mixed esters can be better than cellulose acetates depending on the specific application/processing. In embodiments, acetyl groups (with appropriate DS) have been shown to provide good biodegradability properties for the articles.

In embodiments, a biodegradable elongated tubular member (e.g., tube) is provided that is made from BCA, the backbone of which is made from cellulose itself. The BCA polymer itself, evaluated as a powder, has been certified as biodegradable using industrial composting, home composting, soil, and fresh water. Although one application is straws, other biodegradable products disclosed herein may include stirrers, tubes used as packaging containers, or capsules are also included.

In another aspect, a process is provided by which a cellulose ester (CE) composition, e.g., a BCA composition, is made into a tube. In embodiments, tube is made by extrusion of a solvent solution of the CE, e.g., BCA, into a non-solvent (precipitation) bath allowing controlled phase inversion to create a solid structure with micropores. The phase inversion created by exposure to a non-solvent, e.g., water, allows precise control of the creation of micropores and micro-voids in the wall of this tube. In embodiments, the color of the tube will be white due to the internal reflection of light from the air/polymer interfaces. In embodiments, the porosity can vary from about 10% to about 50%, such as a porosity of about 30%. The density of BCA in a wall of the elongated tubular member may be about 1.3 g/cm³. In embodiments, the density of the tubular member, e.g., a typical straw, produced through phase inversion can be about 0.95 g/cm³. If desired, dyes or colorants could be added to the polymer solution to add color to the wall of the tube.

In embodiments, a process for producing a biodegradable elongated tubular member (as described in any of the embodiments herein) is provided that comprises providing a cellulosic dope composition (or casting solution) comprising a biodegradable cellulosic component dissolved in one or more solvents. The biodegradable cellulosic component includes one or more cellulose esters. The process also may include delivering and metering the cellulosic dope composition through at least one orifice configured to form a tubular shape. The process also may include transferring the one or more solvents from the tubular shaped cellulosic dope composition by mass transfer into a solvent capturing medium that comprises one or more non-solvents to form a substantially solid tube having a plurality of pores. The process also may include processing the substantially solid tube to provide the biodegradable elongated tubular member.

In embodiments, the one or more cellulose esters comprises a biodegradable cellulose acetate. In embodiments, the one or more solvents comprise one or more of acetone, n-methyl-2-pyrrolidone (NMP), tetrahydrofuran (THF), another water miscible solvent, or combinations thereof. In an embodiment, the one or more solvents comprise acetone in an amount of 95 wt % or more, at least about 90 wt %, at least about 75 wt %, at least about 50 wt %, based on the total weight of the solvents. In embodiments, the cellulosic dope composition has a solids content from about 5% to about 40% by weight, about 5% to 15% by weight, about 10% to about 20% by weight, about 15% to about 25% by weight, about 20% to about 30% by weight, about 25% to 35% by weight, about 30% to about 40% by weight, about 15% to about 20% by weight, about 20% to about 25% by weight, about 22.5% to about 27.5% by weight, about 25% to about 30% by weight, about 27.5% to about 32.5% by weight, about 30% to about 35% by weight, about 20% to about 22.5% by weight, about 22.5% to about 25% by weight, about 25% to about 27.5% by weight, about 27.5% to about 30% by weight, about 30% to about 32.5% by weight, about 32.5% to about 35% by weight, at least about 20% by, at least about 22.5% by weight, at least about 25% by weight, at least about 27.5% by weight, at least about 30% by weight, at least about 32.5% by weight, about 20% by weight, about 21% by weight, about 22% by weight, about 23% by weight, about 24% by weight, about 25% by weight, about 26% by weight, about 27% by weight, about 28% by weight, about 29% by weight, about 30% by weight, about 31% by weight, about 32% by weight, or about 33% by weight based on the total weight of the dope composition.

In embodiments, the cellulosic dope composition further comprises one or more additives (as discussed herein). In embodiments, the cellulosic dope composition is free from any additives (e.g., additives are absent from the cellulosic dope composition). In embodiments, the solvent capturing medium comprises a majority of water.

In embodiments, the process for producing a biodegradable elongated tubular member is a continuous process wherein the solvent capturing medium comprises the one or more non-solvents and one or more solvents transferred from the cellulosic dope composition. The concentration of solvent capturing medium may be controlled by introducing fresh nonsolvent to the medium and removing solvent laden liquid from the medium. In embodiments, the substantially solid tube is continuously moved through a volume of the solvent capturing medium and fresh non-solvent is introduced countercurrent relative to the movement direction of the tube.

In embodiments, the solvent capturing medium is in the form of a liquid bath (e.g., a water bath) that comprises an elongated tray of liquid having a length sufficient for a moving tube to remain submerged or partially submerged for a time to allow sufficient mass transfer of the solvents to the bath. In embodiments, the bath and/or tray includes a belt conveying device to assist the movement of the tube and to allow stretching of the tube to provide polymer orientation and dimensional control. In embodiments, the bath and/or tray includes a plurality of fixed or rotating guides configured to turn or direct the tube along a desired path.

In embodiments, the at least one orifice is provided in a die having an inlet and an outlet. In an embodiment, the die outlet is submerged in the liquid solvent capturing media. In other embodiments, the die outlet is above the liquid solvent capturing media to provide an air gap between the die outlet and the liquid solvent capturing media as a first stage of solvent removal. In embodiments, the air gap is from about 0.1 mm to about 8 m, or from about 0.1 mm to about 1 m, from about 0.1 mm to about 50 cm, from about 0.1 mm to about 10 cm, or about 0.1 mm to about 50 mm. In one embodiment, the process may include applying steam to the tube to control the surface gloss. For example, steam may be applied to the tube in the air gap between the orifice and the liquid solvent capturing media. In one embodiment, the processing step (d) comprises heat treating the tube.

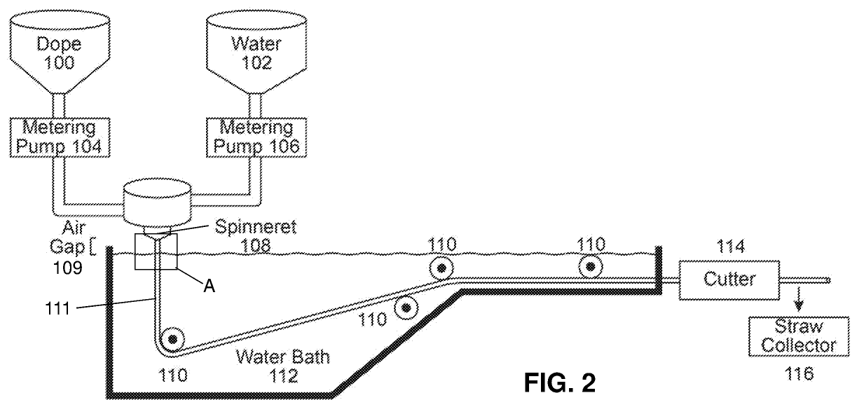

An example of a phase inversion process for extruding and forming an elongated tubular article is shown in FIG. 2, according to an embodiment. The elongated tubular article formed by the process diagramed in FIG. 2 may include any elongated tubular article described herein. For example, the elongated tubular article formed by the process diagramed in FIG. 2 may include any of the cellulose ester crystallizations, densities, porosities, and/or total extractables disclosed herein. The phase inversion process may include a spinning process configured to produce a biodegradable straw or other tubular member. This process can be described in distinct steps.

Referring to FIG. 2, the first step may include accurate delivery of a polymer dope (or casting solution) 100 and a bore fluid (e.g., water) 102 by metering pumps 104,106 to the spinneret (or extrusion die) 108. The polymer dope 100 may include any aspect of any dope or casting solutions described herein. For example, the polymer dope 100 may include any aspect of cellulosic dope compositions described herein, including the various acetylation and weight % described throughout this disclosure. The next step may include evaporation of the volatile solvents in the air gap 109 between the die and the water bath 112. In embodiments, the air gap 109 is absent. Once the dope enters the water bath the phase inversion process starts, and the physical tube begins forming. As the tube 111, guided by wheels 110, is moving through the water bath, the exchange of solvent and water continues, with solvent transferring out of the forming tube 111 and the tube 111 becoming more solid and rigid. The wheels 110 guide the tube to a conveyer belt (not shown) that then pulls the straws through the water bath. The conveyer belt pulls the straw through friction and at the end of the water bath the tube can be automatically cut via a cutter 114 into the desired lengths to make straws. The straws can be further dried or annealed and collected in a straw collector 116. The number and positioning of the wheels 110, pumps 104, 106, spinneret 108, cutter 114, and straw collector 116 in FIG. 2 are for exemplary purposes. Other embodiments of processes for forming a biodegradable tubular member according to this disclosure may include various other numbers and positioning of the wheels 110, pumps 104, 106, spinneret 108, cutter 114, and straw collector 116.

In embodiments, the elongated tubular member, such as a straw, can be subjected to a heat treatment of a predetermined temperature for a predetermined amount of time effective to crystalize at least a portion of the one or more cellulose esters in the elongated tubular member. Crystallization of at least a portion of the one or more cellulose esters in the elongated tubular member may improve the strength of the elongated tubular member. The predetermined temperature of the heat treatment may be about 120° C. to about 150° C., about 120° C. to about 130° C., about 130° C. to about 140° C., about 140° C. to about 150° C., at least about 120° C., at least about 130° C., at least about 140° C., at least about 150° C., less than about 120° C., less than about 130° C., less than about 140° C., or less than about 150° C.

The elongated tubular member may be subjected to the heat treatment for a predetermined period of time, such as about 5 seconds to about 30 seconds, about 5 seconds to about 15 seconds, about 10 seconds to about 20 seconds, about 15 seconds to about 25 seconds, about 20 seconds to about 30 seconds, about 5 seconds to about 10 seconds, about 10 seconds to about 15 seconds, about 15 seconds to about 20 seconds, about 20 seconds to about 25 seconds, about 25 seconds to about 30 seconds, at least about 5 seconds, at least about 10 seconds, at least about 15 seconds, at least about 20 seconds, at least about 25 seconds, less than about 30 seconds, less than about 25 seconds, less than about 20 seconds, less than about 15 seconds, or less than about 10 seconds.

Subjecting the elongated tubular member to the heat treatment at the predetermined temperature for the predetermined period of time may be effective to crystalize at least a portion of the one or more cellulose ester and/or other biodegradable component in the elongated member, such as crystallization of about 0.5% to about 15%, about 1% to about 10%, about 1% to about 5%, about 5% to about 10%, about 1% to about 2.5%, about 2.5% to about 5%, about 5% to about 7.5%, about 7.5% to about 10%, at least about 1%, at least about 2%, at least about 3%, at least about 4%, at least about 5% at least about 6%, at least about 7%, at least about 8%, at least about 9%, less than about 10%, less than about 9%, less than about 8%, less than about 7%, less than about 6%, less than about 5%, less than about 4%, less than about 3%, less than about 2%, or less than about 1% of the biodegradable cellulosic component in the elongated tubular member. Percent crystallinity may be measured using differential scanning calorimetry (DSC) or other suitable technique.

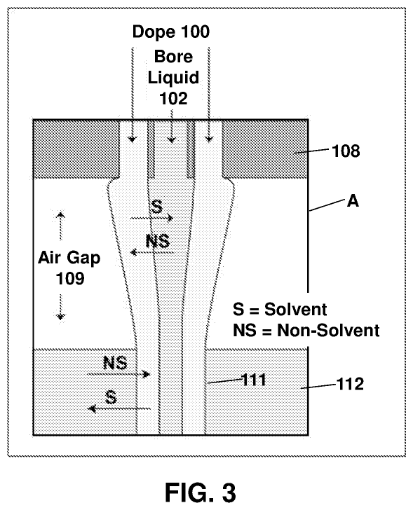

An enlarged cross-sectional view of area A of FIG. 2 is shown in FIG. 3. Referring to FIG. 3, in embodiments, the polymer dope (or casting solution) 100 containing cellulose ester polymer and solvent is extruded through an annular orifice (or opening) in the spinneret 108 and bore liquid (e.g., water) 102 containing non-solvent is co-extruded through an orifice (or opening) in the center of the annular opening in the spinneret 108. The polymer solution of the dope 100 and the bore liquid 102 exit downward from the spinneret 108 into the air gap 109 above a non-solvent containing (e.g., water) bath 112 and continue to flow into the bath 112. There is exchange of solvent and non-solvent between the polymer solution dope 100 and the bore liquid 102 and between the polymer solution dope 100 and the bath 112. The polymer tube 111 may begin to take shape and form in the air gap 109 and continues to form and be shaped in the bath 112.

The process allows production of tubes that will meet the fitness for use requirements to function for example as a straw. This process can be controlled to determine the physical properties of the tube, including the dimensions, including length, inner and outer diameter, and thickness, the porosity and the strength of the tube wall. In embodiments, the dimensions and especially the wall thickness and strength are selected to allow the tubes to be used for an intended purpose, such as straws with thicker (or heavier) walls for thick beverages (such as milkshakes) without collapsing under the negative pressure, or thinner (or lighter) versions for drinking water, soft drinks, teas and coffees. In embodiments, the tube is configured to be used for cocktails or as stirrers.

Applications outside single use food consumption articles could also include packaging. Examples are biodegradable honey sticks or fertilizer sticks (tubes filled with fertilizer) that can be stuck in (inserted into) the soil and slowly release the fertilizer as the tube wall degrades.

In one aspect of this disclosure, one or more single use items that are biodegradable are produced. One specific aspect of biodegradability is compostability, both home compostability as well as industrial compostability. Home compostability is more difficult to achieve as it takes place with less mechanical agitation and at lower temperatures. The presence of micro-voids and pores in embodiments of the products produced according to this disclosure can be configured to aid in biodegradation. While not being bound by theory, it is believed larger surface area can provide improved enzyme/bacterial access to the whole structure of the straw. Further, it is believed that sufficient pore volume will increase the fragmentation speed, as well as reduce the amount of polymer per straw. Straws having a porous structure in accordance with the embodiments discussed herein were found to biodegrade at a relatively rapid rate. This was shown using an 8-inch, ¼″ OD straw with 10 mil wall thickness produced with a phase inversion process which home composted in 23 weeks.

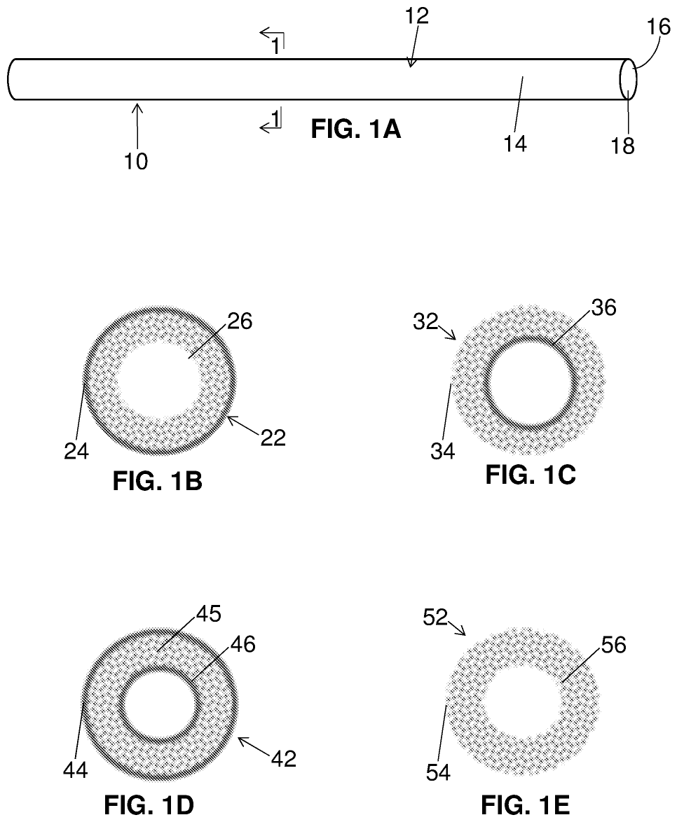

FIG. 1A is a side view of a biodegradable product 10 having an elongated tubular member 12. The elongated tubular member 12 may include a wall having an outer surface 14 and an inner surface 16 defining a through hole 18. The biodegradable product 10 includes a straw and may be formed according to any process disclosed herein. Moreover, the biodegradable product 10 may include any aspect or characteristic of other biodegradable products and elongated members disclosed herein. The biodegradable product 10 may be formed in a phase inversion process In embodiments, the phase inversion process can generally be divided into four elements. The four elements of the phase inversion process may be used to form or produce any of the biodegradable products disclosed herein. The first element may include selection of a cellulose ester, e.g., cellulose acetate, with the optimal degree of substitution to be solvent spun and phase inverted to obtain a suitable tube with targeted dimensions, physical properties such as toughness and stiffness, and biodegradation properties.

A second element may include the dope formulation. In embodiments, the dope formulation can be simple only containing cellulose acetate at concentrations from 1% to 40%, in acetone or a similar suitable water miscible solvent and water. In embodiments, the dope formulation can be more complex and contain at least one of one or more other polymers, one or more other non-solvents, or one or more of a wide range of additives. Additives can include, but not be limited to, additives to control ionic strength, glycerin to stabilize the nascent tube, plasticizers to control toughness and flexibility, additives to promote biodegradation, additives to change appearance, such as dyes and colorants and additive agents that can modify wall surface smoothness. In embodiments, the dope formulation is free of additives (e.g., additives are absent from the dope formulation).

A third element may include the spinning conditions, such as spinning speed, draw ratio, temperature, air flow to remove the acetone, steam flow to induce phase inversion, and phase inversion media, e.g., solutions that can include water, solvent and additives. In embodiments, the conditions can be selected to determine the dimensions of the tube, such as inner and outer diameter, wall thickness, porosity and physical strength of the tube in terms of lateral and perpendicular compression resistance.

A fourth element may include post treatment. In a continuous process, before or after the continuous tube is cut into targeted lengths, the tubes may need to be dried or even annealed to remove acetone and water. At high enough temperatures, annealing may also increase the polymer wall strength. In embodiments, the dimensions of the tubes are controlled by the design of the spinning die (or spinneret) and include, but are not limited to, articles such as stirring sticks and milkshake tubes.

In embodiments, the strength and biodegradability can be a function of the pores in the tube created by phase inversion. In embodiments, there are four different configurations of an biodegradable elongated tubular member can be achieved by the combination of solvent evaporation, phase inversion and annealing, as shown in FIGS. 1B to 1E. FIGS. 1B to 1E are cross-sectional views along line 1-1 of FIG. 1A, according to different embodiments. Referring FIG. 1B, a tubular member 22 may include a skin or outer portion 24 formed on the outer surface of the tubular member 22. The skin or outer portion 24 may have a higher density (or lower porosity) than the remainder of the tubular member 22, including the inner portion 26 or surface. Formation of the skin or outer portion 24 can be controlled by the air gap between the spinneret and the coagulation bath. In this air gap, evaporation of the solvent(s) occurs impacting the mass transfer rates. Eliminating the air gap or reducing the residence time in the air gap can enable the outside to become more porous compared to an air gap with a longer residence time. The temperature and composition of the air gap can also be controlled, by flowing a gas mixture, e.g., nitrogen to mitigate explosion risk, around the air gap. Water vapor or steam can also be used around the air gap to impact morphology of the tubular member. In embodiments, the air gap can comprise a controlled flow rate of a gas and/or vapor configured to control the mass transfer rate and/or pore structure of the outside surface of the tubular member. In embodiments, the controlled flow includes air and/or inert gas, or a blend of air and/or inert gas and solvent vapor. In embodiments, the flow can be concurrent or counter-current to the flow of the tube, or normal to the flow of the tube. In embodiments, the inner wall morphology can be controlled by feeding the cellulosic polymer dope through an annular opening and optionally co-feeding liquid non-solvent (or a non-solvent/solvent mixture) through the center space of the annular opening (bore fluid), where the opening (where the dope exits the spinneret) exists into the airgap above a precipitation bath.

Turning to FIG. 1C, a tubular member 32 may include a skin or inner portion 36 formed on the inner surface of the tubular member 32. For example, the skin or inner portion 36 may define the through hole or passageway in the tubular member. The skin or inner portion 36 may have a higher density (or lower porosity) than the remainder of the cross-section including the outer portion 34. Formation of the skin or inner portion 36 can be controlled by feeding air or another gas through the center space of the tube during formation, e.g., having a spinneret that is configured for feeding the cellulosic polymer dope through an annular opening and co-feeding air or gas through the center space of the annular opening, where the opening (where the dope exits the spinneret) is below the surface (submerged) in a precipitation bath.

Turning to FIG. 10, a tubular member 44 may include both an outer skin layer 44 or inner portion and an inner skin layer 46 or inner portion. The inner skin layer 46 may define the through hole in the tubular member 42, and the tubular member 42 may include an intermediate layer 45 or intermediate portion positioned between the inner skin layer 46 and the outer skin layer 44. The inner skin layer 46 and the outer skin layer may have a higher density (or lower porosity) than the remainder of the cross-section, such as the intermediate layer 45. In some embodiments, the density and the porosity of the inner skin layer 46 is substantially equal to the density and the porosity of the outer skin layer 44. In some embodiments, the density of the inner skin layer 46 is greater than the density and porosity of both the outer skin layer 44 and the intermediate layer 45. In some embodiments, the density of the outer skin layer 44 is greater than the density of both the inner skin layer 46 and the intermediate layer 45. Formation of the inner skin layer 46 and the outer skin layer 44 can be controlled by an air gap between the spinneret and the precipitation bath and also feeding air or another gas through the center space of the tube during formation.

Turning to FIG. 1E, some embodiments of a tubular member 52 may include no skin layers formed on the inner surface 56 and the outer surface 54 (e.g., skin layers are absent from tubular member 52. The cross-section of the tubular member 52, then, has a relatively uniform density (or porosity). Formation of tubular members 52 having no skin layers can be controlled by feeding the cellulosic polymer dope through an annular opening and optionally co-feeding liquid non-solvent (or a non-solvent/solvent mixture) through the center space of the annular opening, where the opening (where the dope exits the spinneret) is below the surface (submerged) in a precipitation bath.

In embodiments, the inner wall porosity can be impacted by the bore fluid. The bore fluid can be composed of selected solvent and non-solvents similar to that of the coagulation batch. The flow rates and temperature can also be adjusted. The choice of solvents and non-solvents, as well as their relative concentrations, can be selected for the precipitation bath and/or the bore fluid to provide a desired density (or porosity) profile for the cross-section of the tube wall.

In embodiments, a gas (or vapor) can be used to flow through the inner annulus to shape the inner walls of the tube. In embodiments, the gas can be air or a blend of air and solvents/non-solvent vapors, e.g., water vapor mixtures. The relative concentrations of the gas/vapor components, as well as temperature and pressure, can also be controlled to achieve a desired morphology profile for the inner wall. This approach allows for the formation of a dense inner wall surface. In one embodiment, the inner wall has a porosity of 10% or less, or 5% or less, e.g., has density within 10%, or 5% of the dry polymer itself.

In embodiments, the skin layer in any of the embodiments discussed herein is substantially impermeable to water. In embodiments, the elongated tubular member according to any of the embodiments discussed herein has an average porosity from 20 to 70%, or from 40 to 60%. In embodiments, the wall of the elongated tubular member according to any of the embodiments discussed herein has a density from about 0.6 g/cm³ to about 1.3 g/cm³, about 0.6 g/cm³ to 1.25 g/cm³, about 0.6 g/cm³ to about 1.2 g/cm³, about 0.6 g/cm³ to about 1.15 g/cm³, about 0.6 g/cm³ to about 0.9 g/cm³, about 0.9 g/cm³ to about 1.2 g/cm³, about 0.6 g/cm³ to about 0.8 g/cm³, about 0.7 g/cm³ to about 0.9 g/cm³, about 0.8 g/cm³ to about 1.0 g/cm³, about 0.9 g/cm³ to about 1.1 g/cm³, about 1.0 g/cm³ to about 1.2 g/cm³, about 1.1 g/cm³ to about 1.3 g/cm³, less than about 1.4 g/cm³, less than about 1.3 g/cm³, less than about 1.2 g/cm³, less than about 1.1 g/cm³, less than about 1.1 g/cm³, less than about 1.0 g/cm³, less than about 0.9 g/cm³, less than about 0.8 g/cm³, less than about 0.7 g/cm³, or less than about 0.6 g/cm³.

In one aspect, the dope formulation and the resulting elongated tubular member contains a total of 0 to about 2 wt %, or 0 to about 1 wt %, of any additives, in addition to the cellulose ester, e.g., cellulose acetate. In embodiments, the dope formulation and the resulting elongated tubular member does not contain any additives (e.g., additives are absent from the dope formulation and the resulting elongated tube), in addition to the cellulose ester, e.g., cellulose acetate. In embodiments, the produced tubes produced from processes described herein can be made to only contain BCA. It is believed that this can be a major differentiator from most thermally processed cellulose esters which require processing aids such as plasticizers. In embodiments, such tubes can have the advantage of low or no extractables (e.g., extractables may be absent from the tube), which is desirable to meet certain regulations that govern food contact applications.

As used herein, the term “solvent spinning,” also known as “solution spinning,” refers to the process of producing synthetic polymer fibers or other extruded profiles whereby one or more polymer resins are dissolved in one or more solvents and the resulting liquid solution is forced through one or more orifices, dies or spinnerets to form continuous strands or cylinders. The solvent(s) are then removed from the strands or extruded profile shapes to form solid fibers (or profile shapes) by mass transfer to a gaseous or liquid spinning medium (or non-solvent), e.g., coagulation or precipitation bath. “Dry solvent spinning” or simply “dry spinning” refers to a solvent spinning process which only uses a gaseous spinning medium or anti-solvent (or non-solvent). “Wet solvent spinning” or simply “wet spinning” refers to a solvent spinning process that includes a liquid spinning medium or bath, e.g., coagulation or precipitation bath, but can also include a dry spinning or “air gap” step before the bath. The spinning bath is sometimes referred to as a coagulation or precipitation bath.

The terms spinning die or die are used interchangeably with spinneret. The term inner annulus, inner die cylinder, center space of the annular opening, and bore are used interchangeably. These terms are a description of the geometry of the device that allows the formation of a strand or tube by the forced flow of polymer solution and bore fluid or liquid through one or more orifices. The radial position of the inner die cylinder can be adjusted relative to the outer die cylinder (or annulus) to center the two die components to improve tube wall uniformity. In some designs the inner die cylinder is tapered on its outer diameter and its axial position relative to the outer die cylinder can be adjusted to change the wall thickness or spinnability of the tube.

The orientation of the die, most commonly vertical with the dope exiting straight downwards, can be adjusted at any angle between vertical and horizontal to optimize the spinning process. The die (or spinneret) may be oriented to modify or adjust the tube geometry or assist in guiding the tube, e.g., in the precipitation bath.

The spinning process can also use multiple dies to form multiple tubes, e.g., processed using the same non-solvent media. In embodiments, the multiple dies can be integrated into a common apparatus or system with a common spinning solution feed and common non-solvent feed to the inner annuli of the dies.

The term “spinning solution” or “dope” refers to the liquid solution produced to feed a solvent spinning process. The spinning solution may contain one or more polymer resins (including other biodegradable polymers in addition to cellulose esters) and one or more solvents. The dope may also contain other soluble additives or non-soluble additives (such as a filler, e.g., calcium carbonate), dispersed additives to enhance the spinning process or the final product attributes (including enhanced biodegradation rates). Spinning solutions may be subsequently filtered, tempered to a desired temperature, or shear thinned to optimize the spinning process. It is important to note that dope temperature impacts viscosity and can be adjusted to optimize the spinning process.

The term “solids content” or “percent solids” in the context of a spinning solution refers to the percent, by weight, of all polymer resins and solid additives in the solution relative to the total solution, regardless of the physical state of the non-solvents at the processing temperatures and regardless of their solubility in the solution. The term “resin solids” refers to the weight percent of the polymers in the formulated dope solution.

The term “drawing” or “drafting” in the context of polymer processing refers to the process of inducing strain in the solid or semi-solid polymer article to (a) increase the alignment of the polymer chains in the strain direction and thereby increase the tensile strength in that direction, usually at the expense of elongation or ductility, and/or (b) to reduce the size or change the shape of the article. As used herein, for fiber or profile extrusion processing, drawing is a continuous process downstream of the spinning process, whereby the article is fed through two sets of rolls or some other gripping mechanism which are driven at different speeds to induce a strain along the extruded axis. As used herein, the term “drafting” is used to describe a process within the spinning process, wherein the article is semi-solid and the resistance to produce the strain is provided mostly by the fluid drag resistance of spinning medium.

The term “annealing” refers to the process of heat treating a material for the purpose of changing or homogenizing its physical properties, including ductility, tensile strength, internal stresses, morphology, and/or surface smoothness. The heat treatment can include increasing the temperature and/or decreasing the temperature, of all or a portion of the article, to a desired set point and/or at a control rate of change. As used herein, in the context of fiber or extruded profile processing, annealing is a process, e.g., a continuous process, whereby the article is passed through a heating or cooling process or heating medium, whereby the temperature change is induced by convective, conductive, or radiant heat transfer or by electromagnetic wave induction. During post processing, heat treatment can be applied to the tube to remove traces of solvent and of free acyl groups, to anneal or strengthen the tube, or to modify the dimensions and surface roughness of the tubes. In embodiments, heat treatment can be applied through a heated cylindrical die, e.g., to modify the dimensions of the tube.

The term “mass transfer rate” refers to the net rate (unit mass or weight per unit time) of solvent movement from the spun article to the spinning medium or non-solvent. The mass transfer rate is a function of many variables that effect the diffusion rate of the solvent within the article cross section and the convection rate of the solvent from the article surface to the spinning medium. These variables include the article temperature and percent solids and the spinning medium's solvent concentration, temperature, and velocity relative to the article.

The term “phase inversion” also referred to as “precipitation” or “coagulation” describes the process in which a polymer solution is introduced into a vessel containing a non-solvent. The non-solvent, often water or aqueous formulations, causes the polymer to precipitate. The solvent and non-solvents can be considered “phases” one in which the polymer system is soluble, the other in which it is not. This precipitation can result in a powder, pellet, fiber or any shape that is formed by the die from which the polymer solution is extruded into the non-solvent containing medium, e.g., precipitation bath. In embodiments, the morphology of the precipitate can depend on the solubility parameters of the solvents, polymer, and non-solvent as well as the processing temperatures. In embodiments, porous morphologies can be provided, where the size of the pores can be controlled by processing conditions.

The term “coagulation bath” or “precipitation bath” describes the vessel in which the dope enters from the spinneret to the exit where a continuous tube can be wound or cut to targeted lengths. In embodiments, the solvent concentration of this bath can be controlled using counter current techniques to maintain a set composition (or composition profile). In embodiments, a vertical configuration can be used which, through the use of guide wheels, determines the depth the nascent tube creates a pressure differential that impacts the dimensions of the forming tube.

In one embodiment, the elongated tubular member is configured to be useful as a drinking straw. In embodiments, configuration as a drinking straw includes meeting customary fitness for use criteria for a plastic straw such as strength, where the straw will not crack when pinched and not collapse when low pressure (due to sucking up a drink) is applied; taste and odor, where the straw will not impart an unacceptable taste or smell (e.g., as determined by a sensory test panel); feel, where the straw has a pleasant feel (e.g., mouth feel), and does not have sharp edges or roughness; and appearance, where the straw is recognizable as a drinking straw.

In embodiments, the elongated tubular member comprises a wall thickness in the range from about 3 mils to about 20 mils (about 76 nm to about 508 nm), from about 4 mils to about 15 mils (about 102 nm to about 381 nm), about 3 mils to about 6 mils, about 6 mils to about 9 mils, about 9 mils to about 12 mils, about 12 mils to about 15 mils, about 15 mils to about 18 mils, about 18 mils to about 20 mils, less than about 20 mils, less than about 15 mils, less than about 10 mils, or less than about 5 mils. In embodiments, the elongated tubular member has an outer diameter of about 1 mm to about 20 mm, about 1 mm to about 5 mm, about 5 mm to about 10 mm, about 10 mm to about 15 mm, about 15 mm to about 20 mm, at least about 1 mm, at least about 5 mm, at least about 10 mm, at least about 15 mm, at least about 20 mm, less than about 20 mm, less than about 15 mm, less than about 10 mm, or less than about 5 mm. In embodiments, the elongated tubular member has a length of about 1 cm to about 50 cm, about 1 cm to about 10 cm, about 10 cm to about 20 cm, about 20 cm to about 30 cm, about 40 cm to about 50 cm, at least about 1 cm, at least about 10 cm, at least about 20 cm, at least 30 cm, at least about 40 cm, at least about 50 cm, less than about 50 cm, less than about 40 cm, less than about 30 cm, less than about 20 cm, less than about 10 cm, less than about 5 cm, or less than about 1 cm.

In embodiments, the elongated tubular member is configured to be useful as a stirring straw. In embodiments, the elongated tubular member has an outer diameter in the range from about 1 mm to about 3 mm and a length from about 4 cm to about 12 cm. In embodiments, the elongated tubular member is configured to be useful for packaging applications. In embodiments, the elongated tubular member has closed ends and encapsulates food material. In certain embodiments, the elongated tubular member has closed ends and encapsulates materials useful for agricultural or horticultural applications.

In embodiments, the elongated tubular member has a low total extractables when tested in water or an alcohol (e.g., ethanol) solution. For example, in embodiments, the elongated tubular member comprises a total extractables amount of less than about 12 mg/dm², less than about 11 mg/dm², less than about 9 mg/dm², less than about 8 mg/dm², less than about 7 mg/dm², less than about 6 mg/dm², less than about 5 mg/dm², about 5 mg/dm² to about 12 mg/dm², about 5 mg/dm² to about 10 mg/dm², about 5 mg/dm² to about 7 mg/dm², about 6 mg/dm² to about 8 mg/dm², about 7 mg/dm² to about 9 mg/dm², about 8 mg/dm² to about 10 mg/dm², about 5 mg/dm² to about 6 mg/dm², about 6 mg/dm² to about 7 mg/dm², about 7 mg/dm² to about 8 mg/dm², about 8 mg/dm² to about 9 mg/dm², or about 9 mg/dm² to about 10 mg/dm². The total extractables in the elongated tubular member may be measured as follows: an 8-inch segment of the elongated tubular member is cut into 4 pieces and placed in a 20 mL headspace vial and 10 wt % ethanol in water is added to the vials such that all segments are fully immersed. The vial is then capped and placed in an oven at 70° C. for 2 hours and the resulting solution is analyzed by HPLA with UV detection (210 nm) to determine the amount of total extractables.

The term biodegradable cellulose acetate (“BCA”), refers to cellulose acetate having an acetyl degree of substitution of 1 to 2.8, or 1.5 to 2.6. In embodiments, the BCA has a number average molecular weight (Mn) in the range from 10,000 to 90,000 measured by gel permeation chromatography with polystyrene equivalents using NMP as the solvent. In embodiments, the BCA has an average degree of polymerization of 100 to less than 150. The molecular weight distribution of the BCA can be a single distribution, or the molecular weight distribution can be multimodal. In embodiments, the cellulose acetate composition comprises 20 to 70% bio content, and optionally also up to 60% acetyl content derived from recycled plastic (Recycle BCA).

In embodiments, the cellulose acetate utilized herein can be any that is known in the art and that is biodegradable. Cellulose acetate that can be used in one or more embodiments disclosed herein generally comprises repeating units of the structure:

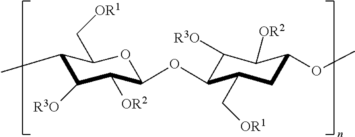

wherein R¹, R², and R³are selected independently from the group consisting of hydrogen or acetyl. For cellulose esters, the substitution level is usually express in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cases, there can be unsubstituted anhydroglucose units, some with two and some with three substituents, and typically the value will be a non-integer. Total DS is defined as the average number of all of substituents per anhydroglucose unit. The degree of substitution per AGU can also refer to a particular substituent, such as, for example, hydroxyl or acetyl. In embodiments, n is an integer in a range from 25 to 250, or 25 to 200, or 25 to 150, or 25 to 100, or 25 to 75.

In an aspect, the elongated tubular member comprises one or more cellulose esters and is biodegradable (according to any or the embodiments discussed herein). In embodiments, the one or more cellulose esters comprises at least a cellulose acetate. The cellulose acetate may have an acetyl degree of substitution (DS Ac) from about 0.05 to about 2.95, about 0.05 to about 1, about 1 to about 2, about 2 to about 2.95, about 0.05 to about 0.5, about 0.5 to about 1, about 1 to about 1.5, about 1.5 to about 2, about 2 to about 2.5, about 2.5 to about 2.95, about 0.2 to 2.9, about 1.0 to about 2.8, about 1.8 to about 2.8, at least about 0.05, at least about 0.2, at least about 0.5, at least about 0.75, at least about 1, at least about 1.25, at least about 1.5, at least about 1.75, at least about 2, at least about 2.25, at least about 2.75, less than about 0.5, less than about 0.75, less than about 1, less than about 1.25, less than about 1.5, less than about 1.75, less than about 2, less than about 2.25, less than about 2.75, or less than about 2.95. In embodiments, other cellulose esters and polymers are absent from the elongated tubular member, and the elongated tubular member consists essentially of cellulose acetate. In certain embodiments, the one or more cellulose esters comprises a mixed cellulose ester, the mixed cellulose ester comprising at least 2 moieties chosen from acetyl, propionyl, butyryl, other aliphatic acyl group, or aromatic acyl group.

In certain embodiments, the one or more cellulose esters comprises a cellulose acetate having an acetyl degree of substitution (DS Ac) from 0.05 to 2.95 (or any of the degrees of substitution described above) and the tubular member comprises a wall having a porosity of at least about 10%, about 10% to about 80%, about 10% to about 70%, about 10% to about 60%, about 10% to about 50%, about 20% to about 70%, about 20% to about 60%, about 20% to about 50%, about 30% to about 70%, about 30% to about 60%, about 30% to about 50%, about 40% to about 70%, about 40% to about 60%, about 40% to about 50%, at least about 5%, at least about 10%, at least about 20%, at least about 25% at least about 30%, at least about 40% at least about 50%, at least about 60%, at least about 70%, at least about 75%, or at least about 80% determined by density of the article compared to the density of the solid article composition (e.g., polymer composition making up the article) that is substantially without any pores.

In other embodiments, the one or more cellulose esters comprises a cellulose acetate having an acetyl degree of substitution (DS Ac) from 0.05 to 2.95 (or any of the degrees of substitution described above) and the tubular member comprises a wall having a porosity of 5% or less, or a density greater than 1.24 g/cm³.

In embodiments, the articles made from the cellulose acetate compositions described herein are biodegradable and/or compostable articles, e.g., straws or stirrers, are certified as industrial compostable according to ASTM D6400. In embodiments, the biodegradable and/or compostable articles are environmentally non-persistent.

In one embodiment, the environmental non-persistence of the cellulose acetate composition is certified by soil biodegradation following ISO 17566. Determination of the ultimate aerobic biodegradability in soil can be made by measuring the oxygen demand in a respirometer or the amount of carbon dioxide evolved. In embodiments, the environmental non-persistence of the cellulose acetate composition is certified by freshwater biodegradation following ISO 14851. Determination of the ultimate aerobic biodegradability of plastic materials in an aqueous medium can be made by measuring the oxygen demand in a closed respirometer.

In an aspect, the environmental non-persistence of the cellulose acetate composition is shown by marine biodegradation. In embodiments, the biodegradation levels are measured by ASTM D6691, which is a Standard Test Method for Determining Aerobic Biodegradation of Plastic Materials in the Marine Environment by a Defined Microbial Consortium or Natural Sea Water Inoculum of 50%, or 60% or 70% or 80% or 90% or 100% measured after 30 days, or 60 days, or 90 days, or 120 days, or 150 days or 180 days.

Although, in some embodiments, tubes formed as described herein do not require additives of any kind, in certain embodiments compositions can be altered with the addition of additives to improve fitness for use, by modifying properties such as flexibility, appearance (e.g., color and smoothness), and biodegradation amounts and/or rates. In some embodiments, such additives can be introduced in the dope formulations or in some cases in the inversion bath or even annealing steps. The biodegradable cellulose acetates can be formulated into article compositions with the addition of plasticizers (e.g., biodegradable plasticizers), fillers, biopolymers, stabilizers, odor modifiers, and/or other additives. In embodiments, the elongated tubular member comprises one or more functional additives in an amount sufficient to modify strength, toughness, color, opacity, clarity or biodegradability of the elongated tubular member. In embodiments, the one or more functional additives are chosen from salts, plasticizers, colorants, antioxidants, stabilizers, or combinations thereof.

Some examples of biodegradable plasticizers include triacetin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, sucrose acetate isobutyrate, the Resolflex™ series of plasticizers, triphenyl phosphate, glycolates, 2,2,4-trimethylpentane-1,3-diyl bis(2-methylpropanoate), and polycaprolactones. Examples of additives include waxes, compatibilizers, biodegradation promoters, dyes, pigments, colorants, luster control agents, lubricants, antioxidants, viscosity modifiers, antifungal agents, anti-fogging agents, heat stabilizers, impact modifiers, antibacterial agents, softening agents, and combinations thereof. It should be noted that the same type of compounds or materials can be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In embodiments, the cellulose acetate composition comprises a biodegradable CA component that comprises at least one BCA and a biodegradable polymer component that comprises one or more other biodegradable polymers (other than a BCA). In embodiments, the other biodegradable polymer can be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS), cellulose esters, starch, proteins, derivatives thereof, and combinations thereof. In embodiments, the cellulose acetate composition contains a biodegradable polymer (other than the BCA) in an amount from 0.1 to less than 50 wt %, or 1 to 40 wt %, or 1 to 30 wt %, or 1 to 25 wt %, or 1 to 20 wt %, based on the cellulose acetate composition. In certain embodiments, the one or more biodegradable polymers is chosen from starch, PLA, PHA or combinations thereof. In embodiments, the tubular member comprises cellulose acetate having an acetyl degree of substitution (DS Ac) from about 1.8 to about 2.8 and from 0 to 2 about wt %, or 0 to about 1 wt %, of any other polymers. In embodiments, the tubular member is substantially free or free of any polymers other than cellulose acetate.

In certain embodiments, the cellulose acetate composition comprises at least one stabilizer. Although it is desirable for the cellulose acetate composition to be compostable and/or biodegradable, a certain amount of stabilizer may be added to provide a selected shelf life or stability, e.g., towards light exposure, oxidative stability, or hydrolytic stability. In various embodiments, stabilizers can include: UV absorbers, antioxidants (ascorbic acid, BHT, BHA, etc.), other acid and radical scavengers, epoxidized oils, e.g., epoxidized soybean oil, or combinations thereof.

In embodiments, the cellulose acetate composition comprises at least one filler. In embodiments, the filler is of a type and present in an amount to enhance biodegradability and/or compostability. In embodiments, the cellulose acetate composition comprises at least one filler chosen from: carbohydrates (sugars and salts), cellulosic and organic fillers (wood flour, wood fibers, hemp, carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes (eggshells, distillers grain, and coffee grounds), desiccants (e.g. calcium sulfate, magnesium sulfate, magnesium oxide, calcium oxide), alkaline fillers (e.g., Na2CO3, MgCO3), or combinations (e.g., mixtures) of these fillers. In embodiments, the cellulose acetate compositions can include at least one filler that also functions as colorant additive. In embodiments, the colorant additive filler can be chosen from: carbon, graphite, titanium dioxide, opacifiers, dyes, pigments, toners and combinations thereof. In embodiments, the cellulose acetate compositions can include at least one filler that also functions as a stabilizer or flame retardant.

In embodiments, depending on the application, e.g., single use food contact applications, the cellulose acetate composition can include at least one odor modifying additive. In embodiments, depending on the application and components used in the cellulose acetate composition, suitable odor modifying additives can be chosen from: vanillin, Pennyroyal M-1178, almond, cinnamyl, spices, spice extracts, volatile organic compounds or small molecules, and Plastidor. In one embodiment, the odor modifying additive can be vanillin. The cellulose acetate composition can include an odor modifying additive in an amount from 0.01 to 1 wt % based on the total weight of the composition. Mechanisms for the odor modifying additives can include masking, capturing, complementing or combinations of these.

As discussed above, the cellulose acetate composition can include other additives. In embodiments, the cellulose acetate composition can include at least one compatibilizer. In embodiments, the compatibilizer can be either a non-reactive compatibilizer or a reactive compatibilizer. The compatibilizer can enhance the ability of the cellulose acetate or another component to reach a desired small particle size to improve the dispersion of the chosen component in the composition. In such embodiments, depending on the desired formulation, the biodegradable cellulose acetate can either be in the continuous or discontinuous phase of the dispersion. In embodiments, the compatibilizers used can improve mechanical and/or physical properties of the compositions by modifying the interfacial interaction/bonding between the biodegradable cellulose acetate and another component, e.g., other biodegradable polymer.

In embodiments, the elongated tubular member comprises a total of 0 to about 2 wt %, or 0 to about 1 wt %, of plasticizers or other additives (e.g., processing-aid additives). In some embodiments, the elongated tubular member is substantially free or free of plasticizers or other additives (e.g., processing-aid additives). In other words, plasticizers and/or other additives may be absent from the elongated tubular member.

In embodiments, if desired, the cellulose acetate composition can include biodegradation and/or decomposition agents, e.g., hydrolysis assistant or any intentional degradation promoter additives can be added to or contained in the cellulose acetate composition, added either during manufacture of the BCA or subsequent to manufacture of BCA and melt or solvent blended together with the BCA to make the cellulose acetate composition. In embodiments, additives can promote hydrolysis by releasing acidic or basic residues, and/or accelerate photo (ultraviolet) or oxidative degradation and/or promote the growth of selective microbial colony to aid the disintegration and biodegradation in compost and soil medium. In addition to promoting the degradation, these additives can have an additional function such as improving the processability of the article or improving desired mechanical properties.

One set of examples of possible decomposition agents include inorganic carbonate, synthetic carbonate, nepheline syenite, talc, magnesium hydroxide, aluminum hydroxide, diatomaceous earth, natural or synthetic silica, calcined clay, and the like. In embodiments, it may be desirable that these additives are dispersed well in the cellulose acetate composition matrix. The additives can be used singly, or in a combination of two or more.

Another set of examples of possible decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent can have a relatively high surface area, for example from about 10 to about 300 sq. m/g, or from 20 to 200 sq. m/g, as measured by the BET surface area method. The photoactive agent can be added to the plasticizer if desired. These transition metal compounds can be used singly, or in a combination of two or more.

Examples of rare earth compounds that can used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium sulfate, ceric ammonium nitrate, cerium acetate, lanthanum nitrate, cerium chloride, cerium nitrate, cerium hydroxide, cerium octylate, lanthanum oxide, yttrium oxide, scandium oxide, and the like. These rare earth compounds may be used singly, or in a combination of two or more.

In one embodiment, the BCA composition includes an additive with pro-degradant functionality to enhance biodegradability that comprises a transition metal salt or chemical catalyst, containing transition metals such as cobalt, manganese and iron. The transition metal salt can comprise of tartrate, stearate, oleate, citrate and chloride. The additive can further comprise of a free radical scavenging system and one or more inorganic or organic fillers such as chalk, talc, silica, starch, cotton, reclaimed cardboard and plant matter. The additive can also comprise an enzyme, a bacterial culture, a swelling agent, CMC, sugar or other energy sources. The additive can also comprise hydroxylamine esters and thio compounds.

In certain embodiments, other possible biodegradation and/or decomposition agents can include swelling agents and disintegrants. Swelling agents can be hydrophilic materials that increase in volume after absorbing water and exert pressure on the surrounding matrix. Disintegrants can be additives that promote the breakup of a matrix into smaller fragments in an aqueous environment. Examples include minerals and polymers, including crosslinked or modified polymers and swellable hydrogels. In embodiments, the BCA composition may include water-swellable minerals or clays and their salts, such as laponite and bentonite; hydrophilic polymers, such as poly(acrylic acid) and salts, poly(acrylamide), poly(ethylene glycol) and poly(vinyl alcohol); polysaccharides and gums, such as starch, alginate, pectin, chitosan, psyllium, xanthan gum; guar gum, locust bean gum; and modified polymers, such as crosslinked PVP, sodium starch glycolate, carboxymethyl cellulose, gelatinized starch, croscarmellose sodium; or combinations of these additives.

In embodiments, the BCA composition can comprise a basic additive that can increase decomposition or degradation of the composition or article made from (or comprising) the composition. Examples of basic additives that may be used as oxidative decomposition agents include alkaline earth metal oxides, alkaline earth metal hydroxides, alkaline earth metal carbonates, alkali metal carbonates, alkali metal bicarbonates, ZnO and basic Al2O3. In embodiments, at least one basic additive can be MgO, Mg(OH)2, MgCO3, CaO, Ca(OH)2, CaCO3, NaHCO3, Na2CO3, K2CO3, ZηO KHCO3 or basic Al2O3. In one aspect, alkaline earth metal oxides, ZηO and basic Al2O3 can be used as a basic additive. In embodiments, combinations of different basic additives, or basic additives with other additives, can be used. In embodiments, the basic additive has a pH in the range from greater than 7.0 to 10.0, or 7.1 to 9.5, or 7.1 to 9.0, or 7.1 to 8.5, or 7.1 to 8.0, measured in a 1 wt % mixture/solution of water.

Examples of organic acid additives that can be used as oxidative decomposition agents include acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

Examples of other hydrophilic polymers or biodegradation promoters may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(a-esters), polycarbonates, polyanhydrides, polyacetals, polycaprolactones, poly(orthoesters), polyamino acids, aliphatic polyesters such as poly(butylene)succinate, poly(ethylene)succinate, starch, regenerated cellulose, or aliphatic-aromatic polyesters such as PBAT.

In embodiments, examples of colorants can include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide,; and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triarylcarbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In embodiments, luster control agents for adjusting the glossiness and fillers can include silica, talc, clay, barium sulfate, barium carbonate, calcium sulfate, calcium carbonate, magnesium carbonate, and the like.

Suitable flame retardants can include silica, metal oxides, phosphates, catechol phosphates, resorcinol phosphates, borates, inorganic hydrates, and aromatic polyhalides.

Antifungal and/or antibacterial agents include polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

In embodiments, fragrances can be added if desired. Examples of fragrances can include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

In embodiments, the Recycle BCA is biodegradable and contains content derived from a renewable source, e.g., cellulose from wood or cotton linter, and content derived from a recycled material source, e.g., recycled plastics. Thus, in embodiments, a processible material is provided that is biodegradable and contains both renewable and recycled content, i.e., made from renewable and recycled sources.

In embodiments, the BCA containing article can be biodegradable and have a certain degree of degradation. The degree of degradation can be characterized by the weight loss of a sample over a given period of exposure to certain environmental conditions.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to IS016929 (2013) must reach a 90% disintegration ; (3) the test material must fulfill all the requirements on volatile solids, heavy metals and fluorine as stipulated by ASTM D6400 (2012), EN 13432 (2000) and ISO 17088 (2012); and (4) the material should not cause negative on plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

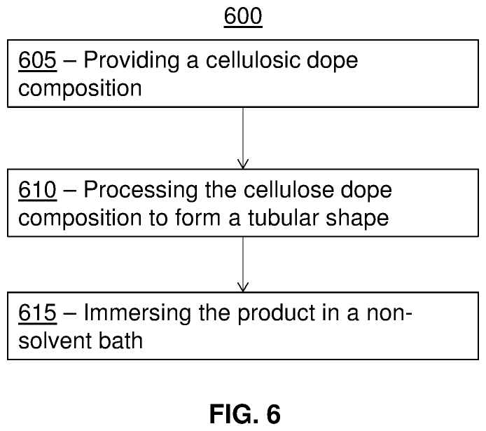

FIG. 6 is a flow diagram of a method or process 600 for producing a biodegradable elongated tubular member, according to an embodiment. Various embodiments of the method 600 may be used to produce any of the biodegradable products disclosed herein. The method 600 also may include any aspects or characteristics of the materials used to form the elongated tubular members described above. The method 600 can include an act 605, which recites “providing a cellulosic dope composition.” The act 605 may be followed by an act 610, which recites “processing the cellulose dope composition to form a tubular shape.” The act 610 may be followed by an act 615, which recites “immersing the product in a non-solvent bath.”

The acts 605, 610, and 630 of the method 600 are for illustrative purposes. For example, the 605, 610, and 630 of the method 600 can be performed in different orders, split into multiple acts, modified, supplemented, or combined. In an example, one or more of 605, 610, and 630 of the method 600 can be omitted from the method 600.

The act 605 recites “providing a cellulosic dope composition.” In some embodiments, the act 605 includes providing a cellulosic dope composition comprising a biodegradable cellulosic component dissolved in one or more solvents, the biodegradable cellulosic component comprising one or more cellulose esters. The one or more cellulose esters comprises a biodegradable cellulose acetate. In some embodiments of the method 600, the biodegradable cellulose acetate has an acetyl degree of substitution of about 0.05 to about 2.95 and the substantially solid tube includes a wall having at least a portion of the plurality of pores and a porosity of at least 10%. In some embodiments of the method 600, the biodegradable cellulose acetate has an acetyl degree of substitution of about 0.05 to about 2.95 and the substantially solid tube includes a wall having at least a portion of the plurality of pores and a porosity of less than about 5% and a density of at least about 1.24 g/cm³. In some embodiments of the method 600, the cellulose acetate has a DS Ac of about 0.2 to about 2.9, about 1.0 to about 2.8, or about 1.8 to about 2.8. In some embodiments of the method 600, the one or more cellulose esters comprise a mixed cellulose ester comprising at least 2 moieties selected from the group consisting of acetyl, propionyl, butyryl, other aliphatic acyl group, and an aromatic acyl group.

In some embodiments of the method 600, the one or more solvents comprises at least one of acetone, NMP, THF, another water miscible solvent, or combinations thereof. In some embodiments of the method 600, the cellulosic dope composition has a solids content of about 5% to about 40% by weight based on a total weight of cellulosic dope composition. In some embodiments of the method 600, the cellulosic dope composition has a solids content of about 25% to about 35% by weight, based on the total weight of the cellulosic dope composition. In some embodiments, the method 600 further includes heating the cellulosic dope composition to about 60° C. to about 80° C.

The act 610 recites “processing the cellulose dope composition to form a tubular shape.” In some embodiments, the act 610 includes delivering and metering the cellulosic dope composition through at least one orifice configured to form the tubular shape.

In some embodiments, the method 600 further includes processing the substantially solid tube to provide said biodegradable elongated tubular member.

The biodegradable elongated tubular member may be biodegradable under the industrially composting conditions described in ASTM D5338 or is industrially compostable as described in ASTM D6400, EN 13432 or ISO 17088.

In some embodiments, the cellulosic dope composition and the substantially solid tube formed according to the method 600 re free of plasticizers. In some embodiments, the cellulosic dope composition and the substantially solid tube formed according to the method 600 are free of additives. In some embodiments, the cellulosic dope composition and the substantially solid tube formed according to the method 600 are free of any polymers other than the one or more cellulose esters. In some embodiments, the substantially solid tube formed according to the method 600 comprises a total extractables amount of about 10 mg/dm² or less in 10 wt % methanol.

In some embodiments, the method 600 further includes cutting the substantially solid tube such that the elongated tubular member is sized and dimensioned as a drinking straw. The drinking straw may include a wall having a wall thickness of about 76 nm to about 508 nm or about 102 nm to about 381 nm. The drinking straw may have an outer diameter of about 1 mm to about 20 mm and a length of about 50 mm to about 500 mm. In some embodiments of the method 600, the substantially solid tube is configured as a stirring straw, a packaging application, or an agricultural or horticultural application.

In some embodiments of the method 600, substantially solid tube includes a wall having an inner portion facing radially inward in the substantially solid tube and an outer portion facing radially outward from the substantially solid tube. The outer portion of the wall may have a density higher than a density of the inner portion of the wall. In some embodiments of the method 600, the wall includes at least a portion of the plurality of pores and has an overall density of about 0.6 to about 1.3 g/cm³.

In some embodiments, the method 600 further includes subjecting the substantially solid tube to a heat treatment of about 120° C. to about 150° C. for about 10 seconds to about 20 seconds effective to crystalize about 1% to about 10% of the biodegradable cellulosic component in the elongated tubular member. In these and other embodiments of the method 600, the one or more cellulose esters may include a cellulose acetate having an acetyl degree of substitution

(DS Ac) of about 0.05 to about 2.95, the elongated tubular member may include a wall including at least a portion of the plurality of pores and having a porosity of at least about 10% and an overall density of about 0.6 g/cm³ to about 1.3 g/cm³, the elongated tubular member may be free of any additives and plasticizers, and the elongated tubular member may include a total extractables amount of about 10 mg/dm² or less in 10 wt % methanol.

It should be noted that embodiments disclosed herein for the biodegradable products may exhibit one or more, two or more, or any combintaion of the physical and chemical properties disclosed herein. For example, the biodegradable products may exhibit one or more, two or more, or any combintaion of DS Ac ranges, porosity ranges, density ranges, extractable ranges, crystallinity ranges, or compostability properties disclosed herein.

The following working examples set forth a formulation and process for forming a CDA straw.

### EXAMPLES

### Example 1: Formation of CDA Straws cut to Target Lengths from a Continuous Tube.

A dope solution of 23 wt % cellulose diacetate having a DS of 2.45 (CDA) in acetone, without any additives, was prepared as follows: a 5 gallon single blade mixing vessel was charged with acetone and then the CDA was added gradually under agitation of 2500 rpm. To help in the dissolution process the vessel was jacketed with warm water and heated to 70° C. The vessel was kept under low pressure to allow entrapped air to escape from the dope. The addition of BDA was continued until a 23 wt % solution was achieved.

A phase inverted (PI) tube was produced through a phase inversion/precipitation spinning process as shown in FIGS. 2 and 3. The degassed dope was poured into the dope vessel 100. The dope vessel had a 10 micron filter at the outlet. The metering pumps 104, 106 were B9000 series Zenith. The pump drives were 1.0 HP by TEFC Motors. The dope pump outlet pressure was 80 psi (add metric). Only deionized water was used for the bore fluid.

To produce a continuous tube, the polymer dope solution was pumped through the orifice around the mandrel in the spinneret. DI water, which was used as the bore liquid was pumped through the center of the mandrel in the spinneret, as can be seen in FIG. 3. The cross-sectional dimensions of the tube, inner diameter, out diameter and wall thickness were in part determined by the geometry of the mandrel and die plate in which the mandrel is centered.

The die outlet was place above the water bath, with a one-inch air gap. As the dope exuded from the die, the acetone evaporated forming a thin skin. It is believed this skin had a significant impact on the solvent exchange as the dope entered the water bath, impacting the morphology of the tube wall.

The process was run at ambient temperature. As the acetone dope entered the water bath, the CDA started precipitating as the acetone exchanged with the water. Initially the dope stream was transparent, but then became visible as the CDA precipitated.

The formed tube had an outer diameter of 5.1 mm, an inner diameter of 4.9 mm, and a wall thickness of 0.11 mm. The tube was cut into straws having 8 inch lengths, which weighed about 0.35 grams each. The density, measured with density gradient solutions, was approximately 0.97g/cm³.

When a straw was placed in a flask in water it floated for a day with only a very small fraction of the straw above the meniscus. After about one day, the straw first became buoyance neutral and then slowly sank to the bottom of the flask. It is believed that water penetrated the micropores and the polymer itself also absorbed water until the density of the submerged straw was nearly the same as that of the water. It was also observed that the straws had no taste, no odor, pleasant smooth feel, and low coefficient of friction.

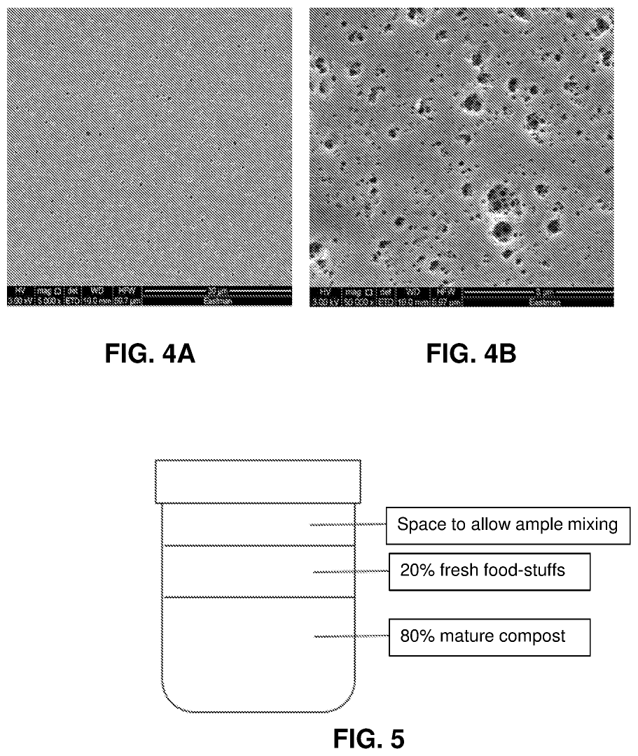

The porosity or morphology of the straws was examined using electron microscopy. The straws were cross sectioned and polished at −40° C. using a cryo-microtome and imaged using SEM. The SEM images are shown in FIGS. 4A and 4B. FIG. 4B is magnified approximately 10 times greater than FIG. 4A. A review of FIGS. 4A and 4B reveals that the straws had pores throughout the wall cross-section that ranged in size up to approximately 500 nm diameter.

### Example 2: Biodegradation Analysis of the Straws

Biodegradation of the straws produced according to Example 1 were evaluated using home composting. A 37 gallon Yimby Compost Tumbler was filled with a mixture of mature compost and food as shown in FIG. 5. The mature compost was purchased from a supplier and combined with food (purchased from a local grocery store) in a 4:1 ratio (compost to food). The compost was thoroughly mixed, and two straws were added. The tumbler was placed outside, where the ambient temperature varied from 80° F. down to 25° F. Under these conditions, it was observed that the straws completely disappeared after 24 weeks.

As used herein, the term “about” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting.

1. A biodegradable product comprising:
an elongated tubular member including one or more cellulose esters and a plurality of pores in the elongated tubular member;
wherein the plurality of pores are sized and structured in the elongated tubular member to allow permeation or infiltration of at least one of water or bacteria into at least a portion of the plurality of pores and promote biodegradability of the elongated tubular member, and
wherein the elongated tubular member is configured as a drinking straw.

2. The biodegradable product according to claim 1, wherein the plurality of pores are sized and structured in the elongated tubular member to promote at least one of biodegradability of the elongated tubular member under the industrially composting conditions described in ASTM D5338 or compostability of the elongated tubular member as described in at least one of ASTM D6400, EN 13432 or ISO 17088.

3. The biodegradable product according to claim 1, wherein the plurality of pores are sized and structured in the elongated tubular member to promote biodegradability of the elongated tubular member under EN 13432 biodegradation tests conducted at ambient temperature or home compostability of the elongated tubular member as described in NF T T51-800 Plastic-specifications suitable for home composting.

4. (canceled)

5. The biodegradable product according to claim 1, wherein the one or more cellulose esters comprises a cellulose acetate having an acetyl degree of substitution (DS Ac) of about 0.05 to about 2.95 and wherein the elongated tubular member includes a wall having at least a portion of the plurality of pores and a porosity of at least 10%, or a porosity of less than about 5% and a density of at least about 1.24 g/cm³.

6-9. (canceled)

10. The biodegradable product according to claim 1, wherein the one or more cellulose esters comprises a mixed cellulose ester comprising at least 2 moieties selected from the group consisting of acetyl, propionyl, butyryl, other aliphatic acyl group, and an aromatic acyl group.

11-13. (canceled)

14. The biodegradable product according to claim 1, wherein the elongated tubular member is free of any polymers other than the one or more cellulose esters, plasticizers, and/or additives.

15-18. (canceled)

19. The biodegradable product according to claim 1, wherein the elongated tubular member comprises a total extractables amount of about 10 mg/dm² or less in 10 wt % methanol.

20. (canceled)

21. The biodegradable product according to claim 1, wherein the elongated tubular member includes a wall having a wall thickness in the range from about 76 nm to about 508 nm.

22. The biodegradable product according to claim 21, wherein the wall thickness is about 102 nm to about 381 nm.

23. The biodegradable product according to claim 1, wherein the elongated tubular member has an outer diameter in the range from about 1 mm to about 20 mm and a length from about 50 mm to about 500 mm.

24-31. (canceled)

32. A process for producing a biodegradable elongated tubular member, the process comprising:
providing a cellulosic dope composition comprising a biodegradable cellulosic component dissolved in one or more solvents, said biodegradable cellulosic component comprising one or more cellulose esters;
processing the cellulosic dope composition to form a tubular shape;
transferring the one or more solvents from the tubular shaped cellulosic dope composition by mass transfer into a solvent capturing medium that comprises one or more non-solvents that removes the one or more solvents from the cellulosic dope composition to form a substantially solid tube having a plurality of pores; and
cutting the substantially solid tube such that the elongated tubular member is sized and dimensioned as a drinking straw.

33. (canceled)

34. The process according to claim 32, wherein the one or more cellulose esters comprises a biodegradable cellulose acetate.

35. The process according to claim 34, wherein the biodegradable cellulose acetate has an acetyl degree of substitution (DS Ac) of about 0.05 to about 2.95 and wherein the substantially solid tube includes a wall having at least a portion of the plurality of pores and a porosity of at least 10%, or a porosity of less than about 5% and a density of at least about 1.24 g/cm³.

36-39. (canceled)

40. The process according to claim 32, wherein the one or more cellulose esters comprises a mixed cellulose ester comprising at least 2 moieties selected from the group consisting of acetyl, propionyl, butyryl, other aliphatic acyl group, or aromatic acyl group.

41-43. (canceled)

44. The process according to claim 32, wherein the biodegradable elongated tubular member is biodegradable under the industrially composting conditions described in ASTM D5338 or is industrially compostable as described in at least one of ASTM D6400, EN 13432 or ISO 17088.

45. The process according to claim 32, wherein the cellulosic dope composition and the substantially solid tube are free of plasticizers, additives, and/or any polymers other than the one or more cellulose esters.

46-47. (canceled)

48. The process according to claim 32, wherein the substantially solid tube comprises a total extractables amount of about 10 mg/dm² or less in 10 wt % methanol.

49. (canceled)

50. The process according to claim 32, wherein the drinking straw includes a wall having a wall thickness of about 76 nm to about 508 nm.

51. The process according to claim 50, wherein the wall thickness is about 102 nm to about 381 nm.

52. The process according to claim 32, wherein the drinking straw has an outer diameter of about 1 mm to about 20 mm and a length of about 50 mm to about 500 mm.

53-58. (canceled)
